(19) United States
(12) Patent Application Publication
(10) Pub. No.: US 2004/0223454 A1
(43) Pub. Date: Nov. 11, 2004

(54) Method and system for maintaining TBS consistency between a flow control unit and central arbiter in an interconnect device

(76) Inventors: Richard Schober, Cupertino, CA (US); Allen Lyu, Saratoga, CA (US)

Correspondence Address: AGILENT TECHNOLOGIES, INC., INTELLECTUAL PROPERTY ADMINISTRATION, LEGAL DEPT., P.O. BOX 7599, M/S DL429, LOVELAND, CO, 80537-0599, US

(21) Appl. No.: 10/434,263

(22) Filed: May 7, 2003

(51) Int. Cl. H04L 12/26

(52) U.S. Cl. 370/229

(57) ABSTRACT

A method and system for maintaining TBS consistency between a flow control unit and central arbiter associated with an interconnect device in a communications network. In one embodiment, a method comprises synchronizing an available credit value between an arbiter and a first flow control unit, wherein the arbiter and flow control unit are part of a first interconnect device. An outgoing flow control message associated with the available credit value is sent; wherein the flow control message prevents packet loss and underutilization of the interconnect device.

### FIELD OF THE INVENTION

The present invention relates generally to the field of data communications and, more specifically, to a method and system for maintaining TBS consistency between a flow control unit and central arbiter associated with an interconnect device in a communications network.

### BACKGROUND OF THE INVENTION

Existing networking and interconnect technologies have failed to keep pace with the development of computer systems, resulting in increased burdens being imposed upon data servers, application processing and enterprise computing. This problem has been exasperated by the popular success of the Internet. A number of computing technologies implemented to meet computing demands (e.g., clustering, fail-safe and 24×7 availability) require increased capacity to move data between processing nodes (e.g., servers), as well as within a processing node between, for example, a Central Processing Unit (CPU) and Input/Output (I/O) devices.

With a view to meeting the above described challenges, a new interconnect technology, called the InfiniBand™, has been proposed for interconnecting processing nodes and I/O nodes to form a System Area Network (SAN). This architecture has been designed to be independent of a host Operating System (OS) and processor platform. The InfiniBand™ Architecture (IBA) is centered around a point-to-point, switched fabric whereby end node devices (e.g., inexpensive I/O devices such as a single chip SCSI or Ethernet adapter, or a complex computer system) may be interconnected utilizing a cascade of switch devices. The InfiniBand™ Architecture is defined in the InfiniBand™ Architecture Specification Volume 1, Release 1.1, released Nov. 6, 2002 by the InfiniBand Trade Association. The IBA supports a range of applications ranging from back plane interconnect of a single host, to complex system area networks, as illustrated in FIG. 1 (prior art). In a single host environment, each IBA switched fabric may serve as a private I/O interconnect for the host providing connectivity between a CPU and a number of I/O modules. When deployed to support a complex system area network, multiple IBA switch fabrics may be utilized to interconnect numerous hosts and various I/O units.

Within a switch fabric supporting a System Area Network, such as that shown in FIG. 1, there may be a number of devices having multiple input and output ports through which data (e.g., packets) is directed from a source to a destination. Such devices include, for example, switches, routers, repeaters and adapters (exemplary interconnect devices). Where data is processed through a device, it will be appreciated that multiple data transmission requests may compete for resources of the device. For example, where a switching device has multiple input ports and output ports coupled by a crossbar, packets received at multiple input ports of the switching device, and requiring direction to specific outputs ports of the switching device, compete for at least input, output and crossbar resources.

In order to facilitate multiple demands on device resources, an arbitration scheme is typically employed to arbitrate between competing requests for device resources. Such arbitration schemes are typically either (1) distributed arbitration schemes, whereby the arbitration process is distributed among multiple nodes, associated with respective resources, through the device or (2) centralized arbitration schemes whereby arbitration requests for all resources are handled at a central arbiter. An arbitration scheme may further employ one of a number of arbitration policies, including a round robin policy, a first-come-first-serve policy, a shortest message first policy or a priority based policy, to name but a few.

The physical properties of the IBA interconnect technology have been designed to support both module-to-module (board) interconnects (e.g., computer systems that support I/O module add in slots) and chasis-to-chasis interconnects, as to provide to interconnect computer systems, external storage systems, external LAN/WAN access devices. For example, an IBA switch may be employed as interconnect technology within the chassis of a computer system to facilitate communications between devices that constitute the computer system. Similarly, an IBA switched fabric may be employed within a switch, or router, to facilitate network communications between network systems (e.g., processor nodes, storage subsystems, etc.). To this end, FIG. 1 illustrates an exemplary System Area Network (SAN), as provided in the InfiniBand Architecture Specification, showing the interconnection of processor nodes and I/O nodes utilizing the IBA switched fabric.

IBA uses a credit-based flow control protocol for regulating the transfer of packets across links. Credits are required for the transmission of data packets across a link. Each credit is for the transfer of 64 bytes of packet data. A credit represents 64-bytes of free space in a link receiver's input buffer. Just as there are separate input buffer space allotments for each virtual lane, there are separate credit pools for each data virtual lane. IBA allows for 1, 2, 4, 8 or 15 data virtual lanes. There is no flow control on the single management virtual lane; hence, there are no credits for the management virtual lane. Link receivers dispense credits by sending a flow control packet to the transmitter in the neighbor device at the opposite end of the link. A sender must have sufficient credits for a given packet before the sender may transmit the packet. For example, a 100-byte packet needs two credits. Sending that packet consumes two credits. On receipt the packet occupies two 64-byte blocks of input buffer space.

The IBA flow control protocol utilizes the following variables:

Virtual Lane (VL)

Total Blocks Sent (TBS)—a cumulative tally of the amount of packet data sent on a link, modulo 4096, since link initialization. TBS is incremented, modulo 4096, for each 64-byte block of packet data sent on a link. A partial block at the end of a packet counts as one block.

Absolute Blocks Received (ABR)—a cumulative tally of the amount of packet data received on a link, modulo 4096, since link initialization. ABR is incremented, modulo 4096, for each 64-byte block of packet data received on a link. A partial block at the end of a packet counts as one block. ABR is not increased if a packet is dropped for lack of input buffer space.

Flow Control Credit Limit (FCCL)—an offset credit count. FCCL equals ABR plus the number of free input buffer blocks, modulo 4096.

TBS, ABR and FCCL are maintained separately for each data virtual lane.

Flow control packets include an operand, a virtual lane specifier, TBS and FCCL values for the specified virtual lane and a cyclic redundancy code (CRC). Upon receipt of a flow control packet with an operand value of zero, the receiver sets its local ABR to the TBS value in the flow control packet. They should be equal because any data sent before the flow control packet should be accounted for in both values. However, transmission errors or hardware glitches could cause them not to be equal.

On receipt of a flow control packet with an operand value of zero, the receiver can compute the number of available credits by subtracting its local TBS from the FCCL value in the flow control packet, modulo 4096. Alternatively, the flow control packet recipient may save the neighbor's FCCL value and determine whether there are sufficient credits by subtracting both the number credits needed for a specific packet transfer and the local TBS value from the neighbor's FCCL, modulo 4096. If the result is less than 2048 (i.e. non-negative), then there are enough credits for that packet transfer.

### SUMMARY OF THE INVENTION

A method and system for maintaining TBS consistency between a flow control unit and central arbiter associated with an interconnect device are disclosed. According to one aspect of the invention, a method comprises synchronizing an available credit value between an arbiter and a first flow control unit, wherein the arbiter and flow control unit are part of a first interconnect device. An outgoing flow control message associated with the available credit value is sent; wherein the flow control message prevents packet loss and underutilization of the interconnect device.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a diagrammatic representation of a System Area Network, according to the prior art, as supported by a switch fabric.

FIGS. 2A and 2B provide a diagrammatic representation of a switch, according to an exemplary embodiment of the present invention.

FIG. 3 illustrates a detailed functional block diagram of link level flow control between two switches, according to one embodiment of the present invention.

FIG. 4 illustrates an exemplary flow control packet and its associated field, according to one embodiment of the present invention.

FIG. 5 illustrates a dual loop flow control diagram for maintaining consistency between a flow control unit and central arbiter in a switch according to one embodiment of the present invention.

FIG. 6 illustrates an exemplary flow diagram consistent with the dual-loop flow scheme of FIG. 5 for sending a flow control packet to a neighboring device.

FIG. 7 illustrates an exemplary flow diagram consistent with the dual-loop flow scheme of FIG. 5, for receiving a stream of packets.

FIG. 8 illustrates an exemplary flow diagram consistent with the dual-loop flow scheme of FIG. 5 for transmitting a data packet.

FIG. 9 illustrates an exemplary flow diagram consistent with the dual-loop flow scheme of FIG. 5 for handling requests.

FIG. 10 illustrates an exemplary flow diagram consistent with the dual-loop flow scheme of FIG. 5 for processing a grant by an output port.

### DETAILED DESCRIPTION

A method and system for maintaining TBS consistency between a flow control unit and arbiter in an interconnect device are described. In the following description, for purposes of explanation, numerous specific details are set forth in order to provide a thorough understanding of the present invention. It will be evident, however, to one skilled in the art that the present invention may be practiced without these specific details.

Note also that embodiments of the present description may be implemented not only within a physical circuit (e.g., on semiconductor chip) but also within machine-readable media. For example, the circuits and designs discussed above may be stored upon and/or embedded within machine-readable media associated with a design tool used for designing semiconductor devices. Examples include a netlist formatted in the VHSIC Hardware Description Language (VHDL) language, Verilog language or SPICE language. Some netlist examples include: a behavioral level netlist, a register transfer level (RTL) netlist, a gate level netlist and a transistor level netlist. Machine-readable media also include media having layout information such as a GDS-II file. Furthermore, netlist files or other machine-readable media for semiconductor chip design may be used in a simulation environment to perform the methods of the teachings described above.

Thus, it is also to be understood that embodiments of this invention may be used as or to support a software program executed upon some form of processing core (such as the CPU of a computer) or otherwise implemented or realized upon or within a machine-readable medium. A machine-readable medium includes any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

For the purposes of the present invention, the term “interconnect device” shall be taken to include switches, routers, repeaters, adapters, or any other device that provides interconnect functionality between nodes. Such interconnect functionality may be, for example, module-to-module or chassis-to-chassis interconnect functionality. While an exemplary embodiment of the present invention is described below as being implemented within a switch deployed within an InfiniBand architecture system, the teachings of the present invention may be applied to any interconnect device within any interconnect architecture.

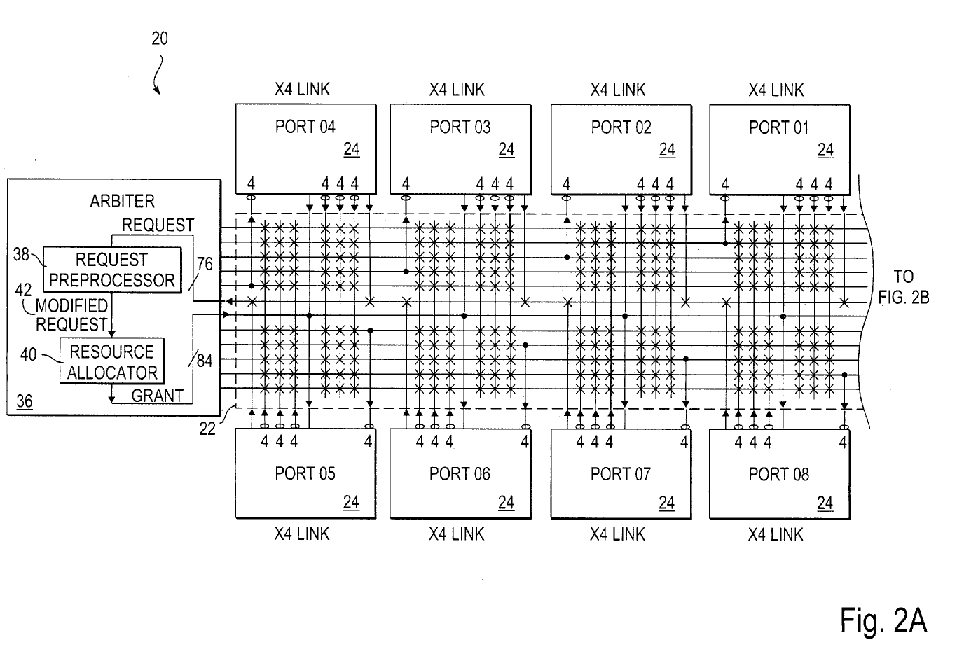

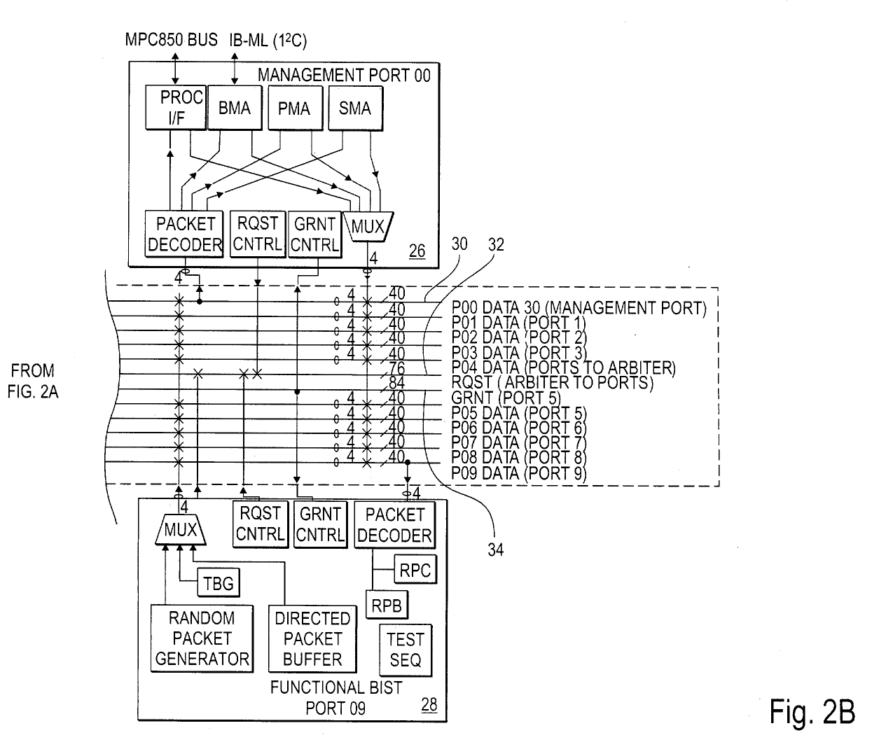

FIGS. 2A and 2B provide a diagrammatic representation of a switch 20, according to an exemplary embodiment of the present invention. The switch 20 is shown to include a crossbar 22 that includes a 104-input by 40-output by 10 bit data buses 30, a 76 bit request bus 32 and a 84 bit grant bus 34. Coupled to the crossbar are eight communication ports 24 that issue resource requests to an arbiter 36 via the request bus 32, and that receive resource grants from the arbiter 36 via the grant bus 34.

In addition to the eight communication ports, a management port 26 and a functional Built-In-Self-Test (BIST) port 28 are also coupled to the crossbar 22. The management port 26 includes a Sub-Network Management Agent (SMA) that is responsible for network configuration, a Performance Management Agent (PMA) that maintains error and performance counters, a Baseboard Management Agent (BMA) that monitors environmental controls and status, and a microprocessor interface.

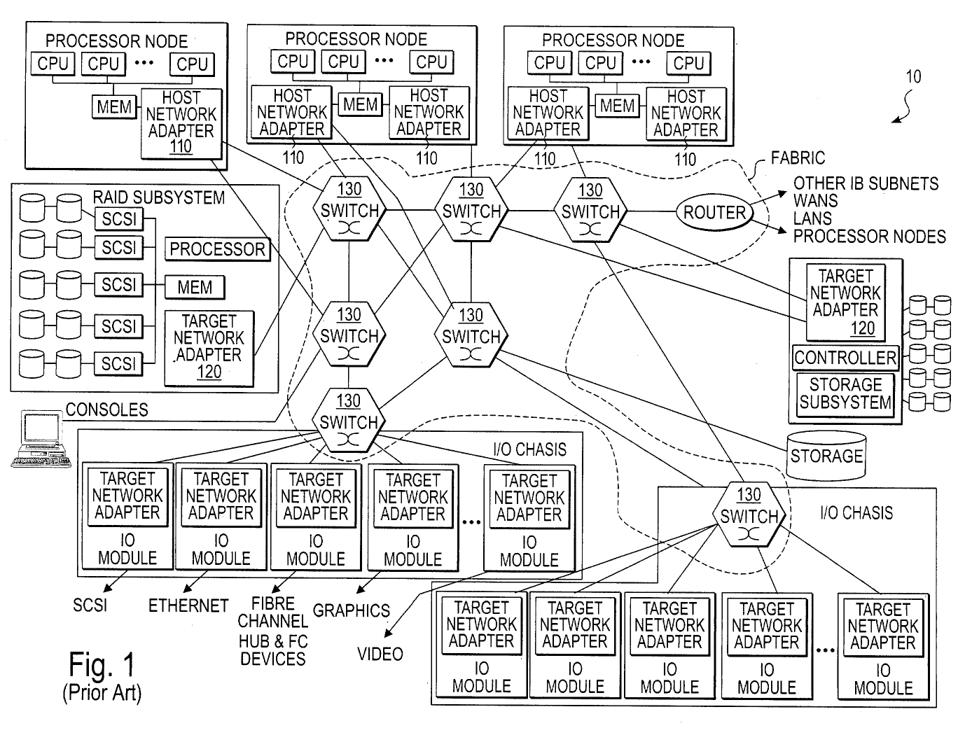

Management port 26 is an end node, which implies that any messages passed to port 26 terminate their journey there. Thus, management port 26 is used to address an interconnect device, such as the switches of FIG. 1. Thus, through management port 26, key information and measurements may be obtained regarding performance of ports 24, the status of each port 24, diagnostics of arbiter 36, and routing tables for network switching fabric 10. This key information is obtained by sending packet requests to port 26 and directing the requests to either the SMA, PMA, or BMA.

The functional BIST port 28 supports stand-alone, at-speed testing of an interconnect device embodying the data path 20. The functional BIST port 28 includes a random packet generator, a directed packet buffer and a return packet checker.

Having described the functional block diagram of a switch, an interconnect device is described where credit allocation is done in a central arbiter, such as arbiter 36. In such a device, link ports 24 maintain their local ABR and TBS counts. The link ports 24 also process incoming flow control packets and generate outbound flow control packets. Whenever a link port 24 receives a flow control packet from a neighboring device, it forwards the FCCL value to the central arbiter 36. In order to compute the number of available credits, the central arbiter, 36 must keep a tally of Total Blocks Granted (TBG). TBG equals the number of 64-byte blocks granted for transmission on a particular virtual lane on a particular output port. After packet transmission, TBS for that same output port, virtual lane combination will have been increased by the same amount as was the corresponding TBG at grant time. If, in effect, TBS is a time-delayed copy of TBG, the flow control protocol functions correctly. At power-on, TBG and TBS are reset to zero; however, normal operating events can cause TBS to deviate from TBG. First, a link may retrain from time to time (e.g. the link error threshold is exceeded and the link automatically retrains). Additionally, a link cable can be unplugged (and replugged) which clears TBS. Second, a packet transmission can be aborted or truncated after the grant is issued because of reception error. Consequently, TBS will not be increased by the same amount as TBG. In such situations, TBS fails to track TBG and the flow control protocol fails. The arbiter 36 thinks it has either more credits or less credits than are actually available resulting in the sending of either too many packets or too few (perhaps even no) packets, respectively. The separate flow control loop between ports 24 and arbiter 36, described below, accurately maintain credit consistency.

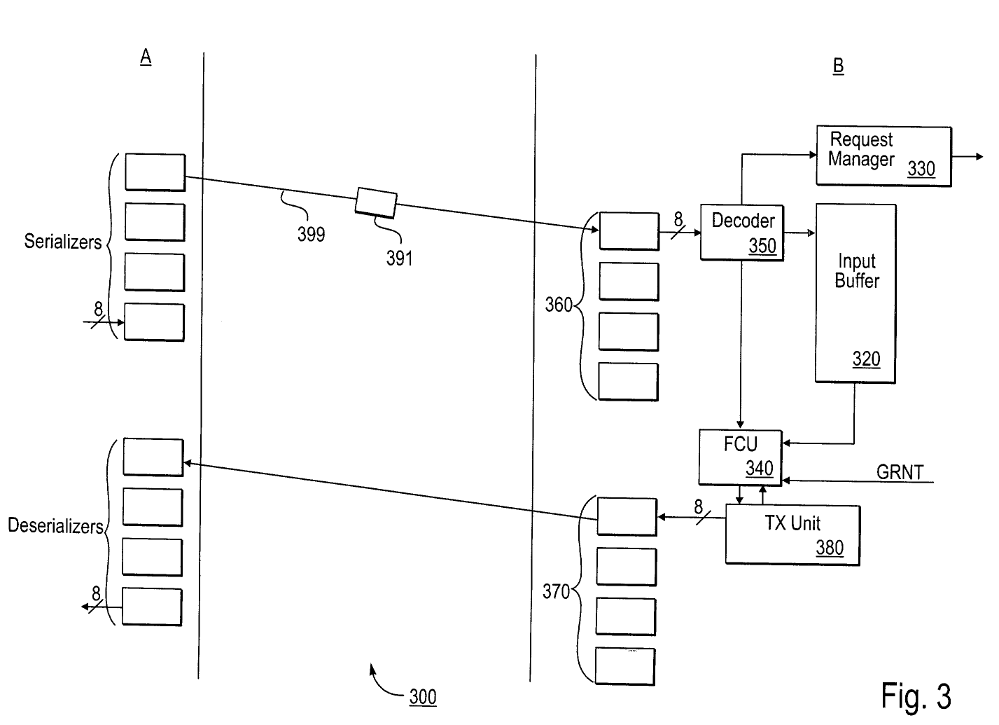

FIG. 3 illustrates a detailed functional block diagram of link level flow control between two switches. Switches A and B of FIG. 3 provide a “credit limit,” which is an indication of the amount of data that the switch can accept on a specified virtual lane.

Errors in transmission, in data packets, or in the exchange of flow control information as discussed above, can result in inconsistencies in the flow control state perceived by the switches A and B. A switch periodically sends an indication of the total amount of data sent since link initialization which is included in a flow control packet.

Flow control packets 391 are sent across link 399 to switch B from switch A. A link 399 has either 1, 4, or 12 serial channels. When a link 399 has more than one channel, data is byte-interleaved across the channels. Flow control is done per link, not per channel. Flow control is implemented on every virtual lane, except one upon which management packets are sent. Flow control packets 391 are transmitted as often as necessary to return credits and enable efficient utilization of the link 399. After a description of flow control packet 391, the signaling of FIG. 3 will be discussed.

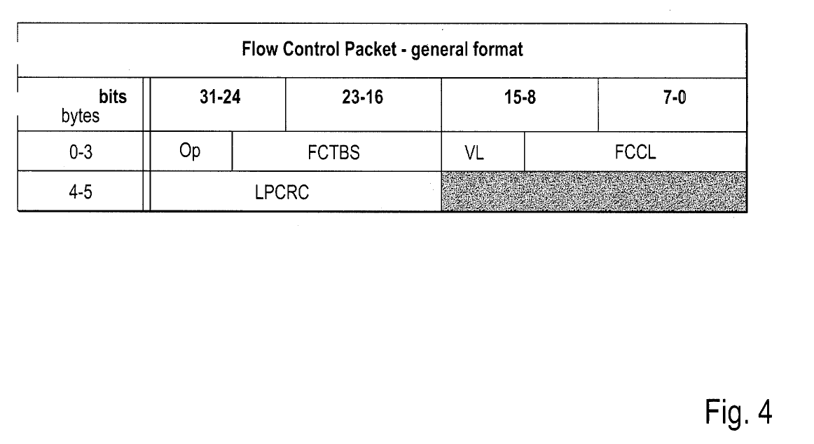

FIG. 4 illustrates a flow control packet 391 that has multiple fields, including a 4 bit operand (OP) field, a 12 bit flow control total blocks sent (FCTBS) field; a flow control credit limit (FCCL) field of 12 bits, a 4 bit virtual lane (VL) field and a link packet cyclic redundancy check (LPCRC). The OP field indicates if the flow control packet is a normal flow control packet or an initialization flow control packet. The FCTBS field indicates the total blocks transmitted in the virtual lane since link initialization. The FCCL field indicates the credit limit mentioned above. A description of how FCCL is calculated is provided below. The VL field is set to the virtual lane to which the FCTBS and FCCL field apply. The LPCRC field covers the first four bytes of the flow control packet.

FCCL is calculated based on a 12-bit Adjusted Blocks Received (ABR) counter maintained for each virtual lane. The ABR is set to zero on initialization. Upon receipt of each flow control packet, the ABR is set to the value of the FCTBS field. When each data packet is received, the ABR is increased, modulo 4096 except when data packets are discarded because the input buffer is full.

Upon transmission of a flow control packet such as packet 391, FCCL will be set to one of the following: If the current buffer state would permit reception of 2048 or more blocks from all combinations of valid packets without discard, then the FCCL is set to ABR+2048 modulo 4096. Otherwise the FCCL is set to ABR plus the “number of blocks receivable” from all combinations of valid packets without discard, modulo 4096. The “number of blocks receivable” is the number that can be guaranteed to be received without buffer overflow regardless of the sizes of the packets that arrive.

Returning now to FIG. 3, switch B is shown having deserializers 360 and serializers 370. Deserializers 360 and serializers 370 may be integrated. Deserializers 360 accept a serial data stream from link 399 and generate 8 byte words that are passed to the decoder 350. For data packets, the flow control unit (FCU) 340 is queried if sufficient storage space is available in the input buffer. If sufficient space for the data packet is available, the packet is stored in the input buffer 320 and the decoder 350 generates a packet transfer request which is passed to the request manager 330. If sufficient space is not available, the packet is dropped. The decoder 350 interprets the incoming stream and routes flow control packets 391 to FCU 340. Also, upon receipt of a flow control packet, the decoder 350 generates a credit update request which is passed on to the request manager 330. The request manager 330 forwards requests through hub 22 to arbiter 36. The data packet is stored in input buffer 320 until the arbiter 36 permits its transmission When a data packet is transmitted the transmit unit 380 keeps FCU 340 notified of the updated TBS(link) and ABR(hub) values. Similarly the input buffer 320 signals FCU 340 that blocks are free when it transmits packets.

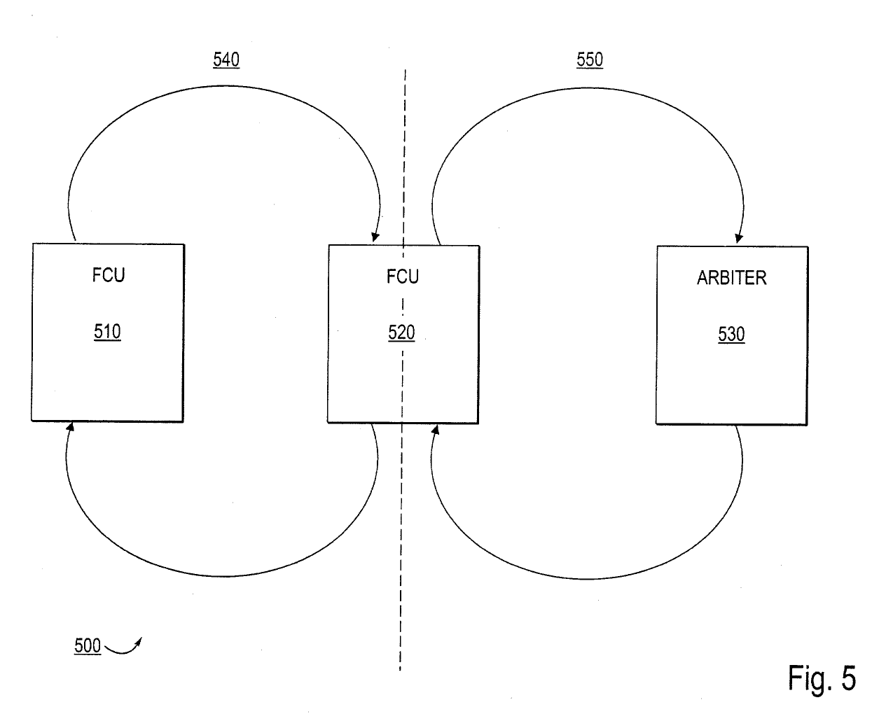

With information from the flow control packet, the FCU 340 keeps track of local credits, and periodically generates outbound flow control messages, as well. The functional blocks of FIG. 3 allow for the dual loop flow control scheme described in conjunction with FIG. 5.

FIG. 5 illustrates a dual loop flow control diagram according to one embodiment of the present invention. FIG. 5 includes a first flow control loop 540 and a second flow control loop 550. FC loop 540 exists between FCU 510 and FCU 520. FCU 510 can be part of switch A and FCU 520 can be part of switch B, both of FIG. 3. FC loop 550 exists between FCU 520 and arbiter 530 on the same switch.

The use of these loops is now discussed in general terms. The basic protocol enables two ports at opposite ends of a link to exchange credits. Credit information is coded in a manner that it is latency tolerant (i.e. tolerant of the time it takes to send a flow control packet across a link). Furthermore, feedback from the credit recipient enables the protocol to recover from the corruption of flow control parameters. The sending of credit information and return of corrective feedback information constitutes the basic flow control protocol loop. Credits from neighboring devices are forwarded to a central arbiter where they are allocated for packet transfers. To facilitate the forwarding of credit information from ports to the central arbiter, the port-arbiter flow control loop 550 of FIG. 5 is created which is separate and distinct from the link-level flow control loop, but uses the same basic protocol. Upon receipt of a flow control packet from the neighbor device, the port maps the credit information from the link-level flow control loop to the port-arbiter flow control loop and forwards it to the arbiter. As on the link, the arbiter provides feed-back to the port to maintain the integrity of the port-to-arbiter loop.

The credit reporting is one-way on the internal loop—conveying neighbor device credit information from ports to the arbiter. The flow control variables used on the port-arbiter flow control Loop are:

Link Total Blocks Sent (TBS (Link))—a cumulative tally of the amount of packet data transmitted on a link, modulo 4096, since link initialization. TBS (Link) can be the TBS value, described above.

Link Absolute Blocks Received (ABR (Link))—a cumulative tally of the amount of packet data received on a link, modulo 4096, since link initialization. ABR (Link) can be the ABR value, described above.

Local Flow Control Credit Limit (FCCL (Local))—an offset credit count. FCCL Local equals ABR (Link) plus the number of free input buffer blocks, modulo 4096, reserved for the relevant virtual lane in the local port's input buffer.

Neighbor Flow Control Credit Limit (FCCL (Neighbor))—an FCCL value which has been received in a flow control packet from the attached neighbor device (Note: FCCL (Neighbor) equals the neighbor's FCCL (Local).

Arbiter Total Blocks Granted (TBG (Arb))—a cumulative tally of the amount of packet data granted for transmission on a link, modulo 4096, since device reset. TBG (Arb) is increased, modulo 4096, by the number of 64-byte blocks in a packet which has been granted permission to be sent out on a particular link. A partial block at the end of a packet counts as one block. The number of blocks in a packet is computed from the packet length value contained in a packet transfer request to the arbiter.

Grant Total Blocks Granted (TBG (Grnt))—equals the value of TBG (Arb) at the time a grant is issued, including the number of credits consumed by the granted packet. The arbiter includes TBG (Grnt) in the grant. The target output port stores TBG (Grnt) in a FIFO until associated packet transmission completes. TBG (Grnt) is used to ensure that ABR (Hub) stays consistent with TBG (Arb) particularly when packet transmissions are aborted or truncated.

Blocks Occupied (BO(Ibfr))—a running total of 64 byte blocks stored within the input buffer.

Hub Absolute Blocks Received (ABR (Hub))—a cumulative tally of the amount of packet data received by a port from the hub on crossbar 22, modulo 4096, since device reset. ABR (Hub) is incremented, modulo 4096, for each 64-byte block of packet data received on a hub. A partial block at the end of a packet counts as one block.

During packet transmission, ABR (Hub) and TBS (Link) shall be increased simultaneously. At the completion of each packet transfer, ABR (Hub) is set equal to the TBG (Arb) value supplied in the grant of the packet transfer. This action ensures that ABR (Hub) stays consistent with TBG (Arb) even when granted packet transmissions are aborted or truncated by the input port because of a packet reception error detected after issuing the arbitration request.

Update Flow Control Credit Limit (FCCL (Updt))—a recomputation of FCCL (Neighbor) for the port-arbiter flow control loop. Specifically, FCCL (Updt) equals FCCL (Neighbor) minus TBS (Link) plus ABR (Hub), modulo 4096. Subtracting TBS (Link) yields the number of credits. Adding ABR (Hub) recodes the credits for the port-arbiter loop. Ports keep a copy of the most recent FCCL (Updt) value for each virtual lane. Whenever an FCCL (Updt) value changes, the port schedules a credit update request to the arbiter.

Arbiter Flow Control Credit Limit (FCCL (Arb))—the most recently reported FCCL (Updt) value reported by a port in a credit update request. FCCL (Arb) is a recompilation of FCCL (Neighbor) for the port-arbiter flow control loop using ABR (Hub) as the base value. The arbiter determines the number of available credits by subtracting TBG (Arb) from FCCL (Arb), modulo 4096.

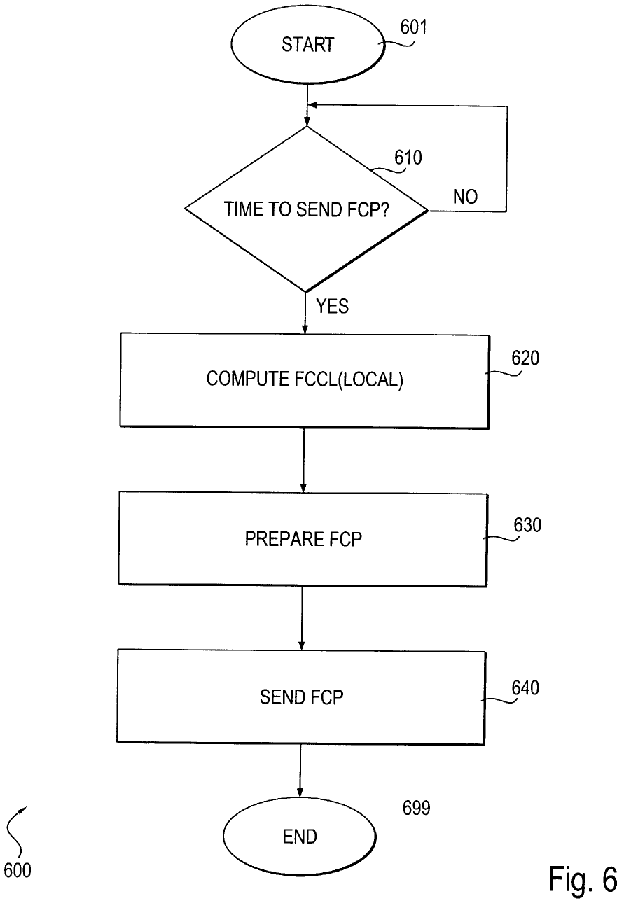

As noted earlier, TBS, ABR and FCCL are maintained separately for each data virtual lane. The signaling within and between loop 540 and loop 550 will be discussed now in connection with FIGS. 6-10.

FIG. 6 is an exemplary flow diagram consistent with the dual-loop flow control scheme of FIG. 5 for a process 600 of sending a flow control packet to a neighboring device. The process 600 begins at block 601. At decision block 610, FCU 340 determines if it is time to send a flow control packet. If it is not time, FCU 340 waits. If it is time to send a flow control packet, FCCL (local) is computed at processing block 620. FCCL is computed as follows:

FCCL (Local) [vl]=(ABR(Link) [vl]+n_credits [vl]) modulo 4096;

where n_credits [vl], the number of credits, is the lesser of the number of free 64-byte blocks in the local input buffer reserved for the relevant virtual lane or 2048. At processing block 630 the flow control packet is prepared. An outbound flow control packet is prepared by setting the following parameters:

FCP.VL=vl;

FCP.TBS=TBS (Link) [vl];

FCP.FCCL=FCCL (Local) [vl];

where FCP.VL, FCP.TBS and FCP.FCCL are the VL, TBS and FCCL fields in the out-bound flow control packet. The flow control packet is sent at processing block 640 and the process terminates at block 699.

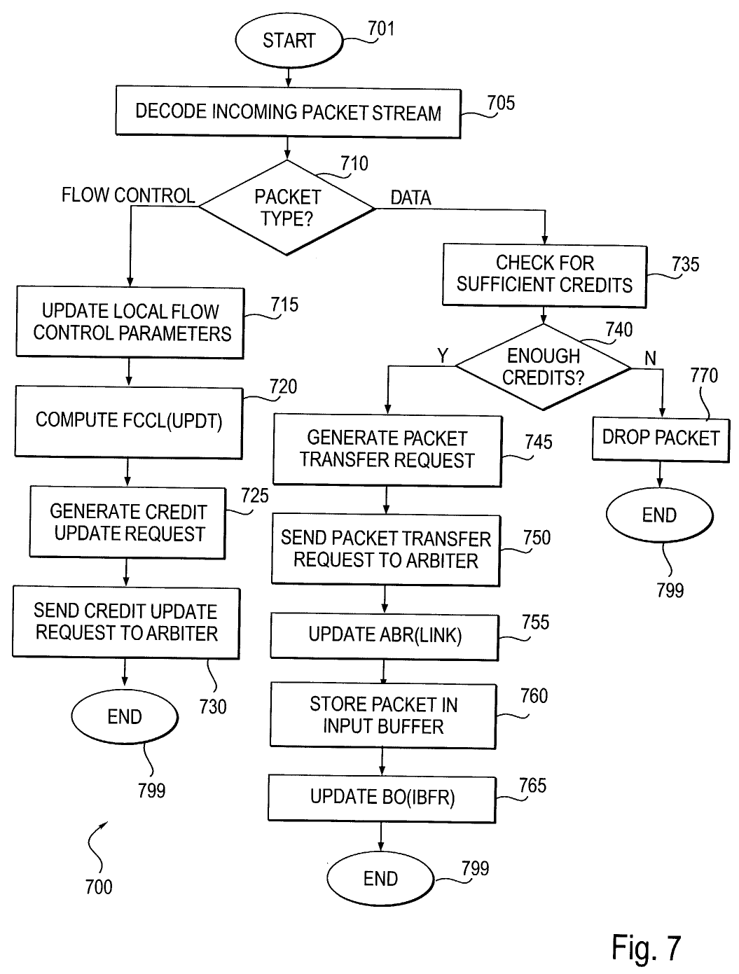

FIG. 7 is an exemplary flow diagram consistent with the dual-loop flow control scheme of FIG. 5, for a process 700 of receiving a stream of packets. The process 700 begins at block 701. At processing block 705, the incoming packet stream is decoded at decoder 350. A packet type is determined at decision block 710. If the packet is a flow control packet, flow continues to processing block 715. If the packet is a data packet, flow continues to processing block 735. The processing of the flow control packet will now be discussed and immediately followed by a description of the processing of a data packet.

Having identified an incoming packet as a flow control packet, at processing block 715 local flow control parameters are updated by FCU 340. Local flow control parameters are updated as follows:

vl=FCP.VL; and

ABR (Link) [vl]=FCP.TBS.

At processing the block 720 FCCL (updt) is computed as follows:

FCCL (Updt) [vl]=(FCP.FCCL−TBS (Link) [vl]+ABR (Hub) [vl]) modulo 4096;

where FCP.VL, FCP.TBS and FCP.FCCL are the VL, TBS and FCCL fields in the incoming flow control packet. Setting ABR (Link) to FCP.TBS ensures that the local link ABR is consistent with the neighbor's link TBS. This action corrects for lost data packets on the link and other errors which would cause these parameters to get out of sync. Subtracting TBS (Link) from FCP.FCCL yields the number of available credits. Adding ABR (Hub) recodes the credit count for port-arbiter flow control loop. The resulting FCCL (Updt) is subsequently forwarded to the arbiter in a credit update request. At processing block 725 a credit update request for the arbiter is generated. The following parameters are set:

:

RQST.VL=vl; and

RQST.FCCL=FCCL (Updt) [vl].

:

At processing block 730, the update request is sent to arbiter 36. The process ends at block 799.

Having described the processing of an incoming flow control packet, the processing of a data packet is presented. Commencing at decision block 735, decoder 350 checks for sufficient credits. If there are insufficient credits, the input buffer has no space to store the data packet, the data packet is dropped at block 770 and the processing ends at block 799.

If sufficient credits exist, a packet transfer request is generated at processing block 745. After receiving a packet's Local Route Header (LRH) and passing some preliminary checks, a packet transfer request is created and forwarded to the arbiter. This request includes, among other things, the packet length field in the LRH which is used by the arbiter to determine the number credits the packet requires.

:

RQST.PCKT_LTH=LRH.PCKT_LTH;

:

At processing block 750, the packet transfer request is sent to arbiter 36. ABR (Link) is updated at processing block 755 as follows. For every 64 bytes of incoming packet data, ABR (Link) [vl]=(ABR (Link) [vl]+1) modulo 4096. A partial block at the end of a packet counts as one block. At processing block 760, the data packet is stored in input buffer 320. The BO(Ibfr) value is updated at processing block 765. For every 64 byte block stored in input buffer 320, BO(Ibfr) is incremented (i.e., BO(Ibfr) [vl]=BO(Ibfr) [vl]+1). Partial blocks are treated as a full block. The process ends at block 799.

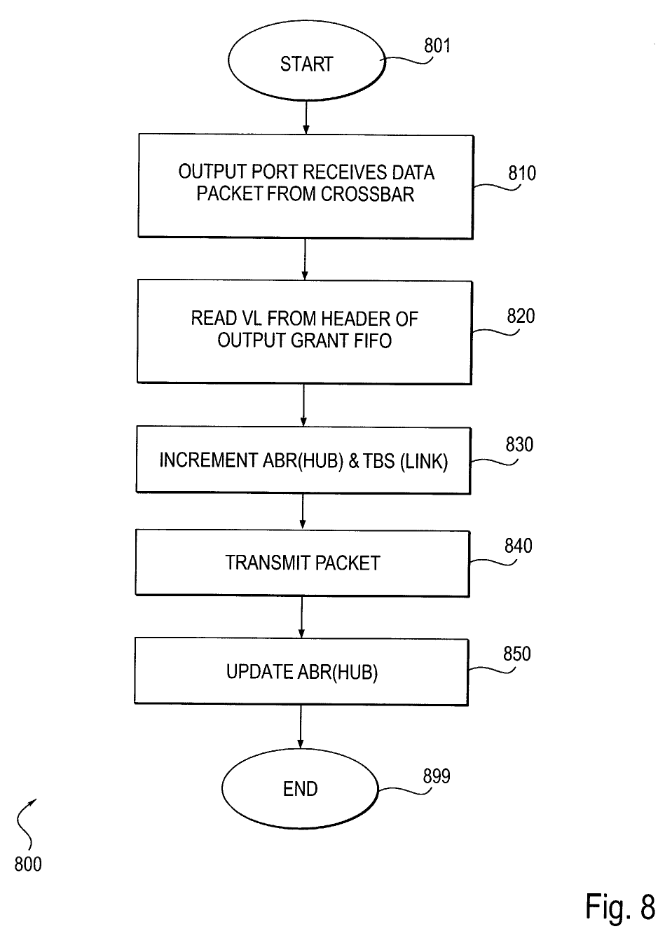

FIG. 8 is an exemplary flow diagram consistent with the dual-loop flow control scheme of FIG. 5 for a process 800 of transmitting a data packet. The process 800 begins at block 801. An output port receives a data packet via crossbar 22 at processing block 810. At processing block 820 the virtual lane is read from the header of output port grant FIFO (vl=VL (Grnt) [head]). For every 64 bytes of outbound packet data which is actually transmitted, the following parameters are incremented at processing block 830:

ABR (Hub) [vl]=(ABR (Hub) [vl]+1) modulo 4096; and

TBS (Link) [vl]=(TBS (Link) [vl]+1) modulo 4096.

Partial blocks at the end of a packet count as one block. During transmission of data packets, ABR (Hub) and TBS (Link) are updated simultaneously. The data packet is transmitted at processing block 840.

If a data packet transmission is aborted or truncated after receiving a good grant, the following actions are taken at processing block 850 to ensure that ABR (Hub) is consistent with TBG(Arb):

ABR (Hub) [vl]=TBG (Grnt)[head]; and

head=(head+1) modulo fifo_size;

where TBG (Grnt) was the value of TBG (Arb) when the grant was issued. It is recommended that this action be taken at the completion of all data packet transmissions since ABR Hub should equal TBG (Grnt). The processing flow stops at block 899.

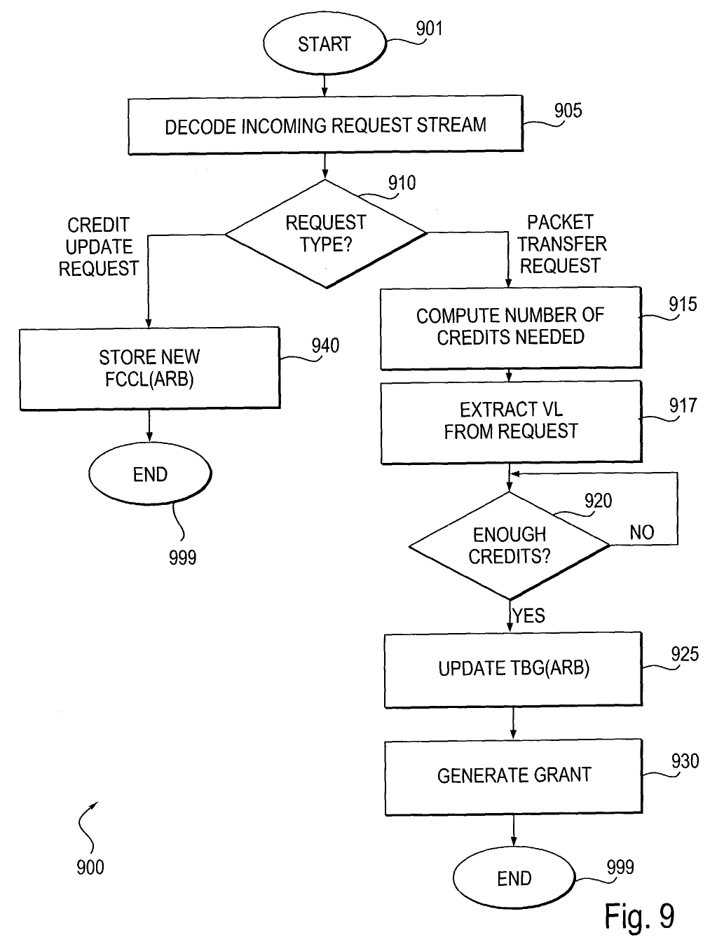

FIG. 9 is an exemplary flow diagram consistent with the dual-loop flow control scheme of FIG. 5 for a process 900 of handling requests in the arbiter 36. The process 900 begins at block 901. At processing block 905, the arbiter 36 decodes an incoming request stream. The request type is identified as a credit update request or packet transfer request at decision block 910. If the request is a credit update request, a new FCCL (arb) value is stored at processing block 940. Upon receiving a credit update, the arbiter 36 sets the following parameters:

vl=RQST.VL; and

FCCL (Arb) [vl]=RQST.FCCL. The process ends at block 999.

If the request is a packet transfer request, then the number of credits needed is computed at processing block 915. The number of credits needed for the packet transfer are computed as follows:

n_credits_needed=(RQST.PCKT_LTH div 16)+1;

where RQST.PCKT_LTH is the packet length field in a packet transfer request. Packet length is given in units of 4 bytes and div is an integer divide. A partial 64-byte block at the end of a packet counts as one credit. Note, the “+1” in the above equation is necessary even when packet_length modulo 16 is zero because packet length does not include the packet's start delimiter (1 byte), variant cyclic redundancy code (vCRC) (2 bytes) or end delimiter (1 byte). IBA requires that these four bytes be included in the credit computation because they may optionally be stored in a receiving port's input buffer.

The virtual lane is extracted from the packet transfer request at processing block 917, and the parameter “vl=RQST.VL” is set. At decision block 920, a check for sufficient credits is performed, as follows:

If (((FCCL (Arb) [vl]−TBG (Arb) [vl]−n_credits_needed) modulo 4096)<2048) is true, there are sufficient credits to send the packet. If there are insufficient credits, then processing stalls until the credits are available. If credits are available processing continues.

At processing block 925, the total blocks granted value is updated as follows with TBG (Arb) [vl]=(TBG (Arb) [vl]+n_credits_needed) modulo 4096. The grant is generated at processing block 930, as follows:

:

GRNT.VL=vl; and

GRNT.TBG=TBG (Arb) [vl].

The process ends at block 999.

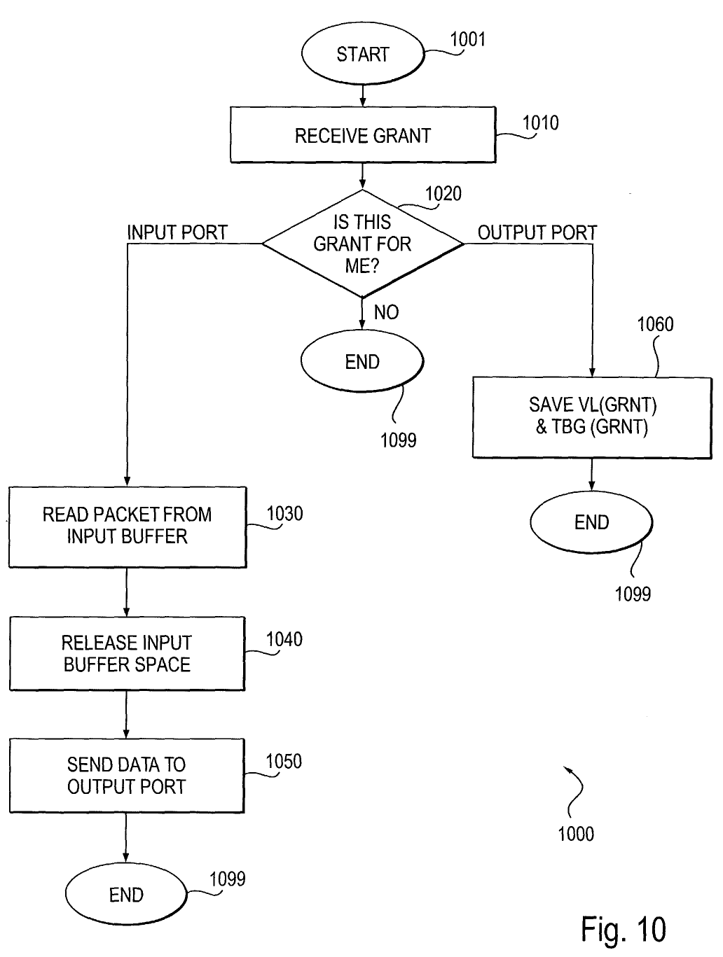

FIG. 10 is an exemplary flow diagram consistent with the dual-loop flow control scheme of FIG. 5 for a process 1000 of processing a grant by the affected input port and output port. The process 1000 begins at block 1001. A grant is received at processing block 1010. At decision block 1020, each port of FIGS. 2A and 2B, determine if the grant is intended for it. If the grant is not intended for the receiving port, the process terminates at block 1099. If the grant is meant for the input port of the port, then at processing block 1030, a packet indicated by the grant is read from the input buffer. At processing block 1040, the input buffer space is released as follows:

vl=GRNT.VL

BO(Ibfr) [vl]=BO(Ibfr) [vl]−1.

The desired data packets are sent to an appropriate output port at processing block 1050. The process ends at block 1099.

However, if the grant is directed to an output port at decision block 1020, upon receipt of a grant, the designated output port saves VL (Grnt) and TBG (Grnt) in a FIFO, the output port grant FIFO, for use after the granted packet transfer has completed. The following parameters are set:

VL (Grnt) [tail]=GRNT.VL;

TBG (Grnt) [tail]=GRNT.TBG; and

tail=(tail+1) modulo fifo_size.

Thus, a method and system for maintaining TBS consistency between a flow control unit and control arbiter associated with an interconnect device, have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method, comprising:
synchronizing an available credit value between an arbiter and a first flow control unit, wherein the arbiter and flow control unit are part of a first interconnect device; and
sending an outgoing flow control message associated with the available credit value; wherein the flow control message prevents packet loss and underutilization of the interconnect device.

2. The method of claim 1, wherein the available credit value is a credit limit that indicates if an input buffer within the first interconnect device can store an incoming data packet.

3. The method of claim 2, wherein synchronizing comprises:
providing a first flow control loop between the first flow control unit and the arbiter; and
providing a second flow control loop between the first flow control unit and a second flow control unit;
wherein the second flow control unit is included in a second interconnect device.

4. The method of claim 3, wherein providing the second flow control loop comprises:
receiving an incoming flow control message at the first flow control unit via the second flow control loop; and
sending data packets to the second interconnect device based on the incoming flow control message via the second flow control loop.

5. The method of claim 3, wherein providing the first flow control loop comprises:
receiving a credit update request at the arbiter via the first flow control loop;
generating a grant at the arbiter based on the credit update request; and
providing the grant to the first flow control unit via the first flow control loop.

6. A system, comprising:
means for synchronizing an available credit value between an arbiter and a first flow control unit, wherein the arbiter and flow control unit are part of a first interconnect device; and
means for sending an outgoing flow control message associated with the available credit value; wherein the flow control message prevents packet loss and underutilization of the interconnect device.

7. The system of claim 6, wherein the available credit value is a credit limit that indicates if an input buffer within the first interconnect device can store an incoming data packet.

8. The system of claim 7, wherein the means for synchronizing comprises:
means for providing a first flow control loop between the first flow control unit and the arbiter; and
means for providing a second flow control loop between the first flow control unit and a second flow control unit;
wherein the second flow control unit is included in a second interconnect device.

9. The system of claim 8, wherein the means for providing the second flow control loop comprises:
means for receiving an incoming flow control message at the first flow control unit via the second flow control loop; and
means for sending data packets to the second interconnect device based on the incoming flow control message via the second flow control loop.

10. The system of claim 8, wherein the means for providing the first flow control loop comprises:
means for receiving a credit update request at the arbiter via the first flow control loop;
means for generating a grant at the arbiter based on the credit update request; and
means for providing the grant to the first flow control unit via the first flow control loop.

11. A system, comprising:
a first interconnect device having an arbiter and a first flow control unit; and
a second interconnect device linked to the first interconnect device; wherein an incoming flow control message received by the first interconnect device is associated with an available credit value that prevents packet loss and underutilization of the first interconnect device.

12. The system of claim 11, wherein the available credit value is a credit limit that indicates if an input buffer within the interconnect device can store an incoming data packet.

13. The system of claim 12, further comprising:
a first flow control loop between the first flow control unit and the arbiter; and
a second flow control loop between the first flow control unit and a second flow control unit;
wherein the arbiter and the first flow control unit are included in the first interconnect device.

14. The system of claim 13, wherein the first interconnect device:
receives an incoming flow control message at the first flow control unit via the second flow control loop; and
sends data packets to the second interconnect device based on the incoming flow control message via the second flow control loop.

15. The system of claim 14, wherein the arbiter:
receives a credit update request from the first flow control unit via the first flow control loop;
generates a grant based on the credit update request; and
provides the grant to the first flow control unit via the first flow control loop.

16. A computer-readable medium having stored thereon a plurality of instructions, said plurality of instructions when executed, cause said computer to perform:
synchronizing an available credit value between an arbiter and a first flow control unit, wherein the arbiter and flow control unit are part of a first interconnect device; and
sending an outgoing flow control message associated with the available credit value; wherein the flow control message prevents packet loss and underutilization of the interconnect device.

17. The computer-readable medium of claim 16, wherein the available credit value is a credit limit that indicates if an input buffer within the first interconnect device can store an incoming data packet.

18. The computer-readable medium of claim 17 having stored thereon additional instructions, said additional instructions when executed by a computer, cause said computer to further perform:
providing a first flow control loop between the first flow control unit and the arbiter; and
providing a second flow control loop between the first flow control unit and a second flow control unit;
wherein the second flow control unit is included in a second interconnect device.

19. The computer-readable medium of claim 18 having stored thereon additional instructions for providing the second flow control loop, said additional instructions when executed by a computer, cause said computer to further perform:
receiving an incoming flow control message at the first flow control unit via the second flow control loop; and
sending data packets to the second interconnect device based on the incoming flow control message via the second flow control loop.

20. The computer-readable medium of claim 18 having stored thereon additional instructions for providing the first flow control loop, said additional instructions when executed by a computer, cause said computer to further perform:
receiving a credit update request at the arbiter via the first flow control loop;
generating a grant at the arbiter based on the credit update request; and
providing the grant to the first flow control unit via the first flow control loop.

21. An interconnect device, comprising:
a flow control unit;
an arbiter connected to the flow control unit; and
an input buffer connected to the flow control unit,
wherein an available credit value is synchronized between the flow control unit and the arbiter via a flow control loop so that one or more data packets can be stored in the input buffer without loss of the one or more data packets.

22. The interconnect device of claim 21, wherein the flow control unit communicates with a second interconnect device to create a second flow control loop.
